(19) United States
(12) Patent Application Publication
(10) Pub. No.: US 2021/0101331 A1
(43) Pub. Date: Apr. 8, 2021

(54) THREE-DIMENSIONAL PRINTED THERMAL EXPANSION STRUCTURE AND MANUFACTURING METHOD OF THE SAME

(71) Applicant: FENG TAY ENTERPRISES CO., LTD., Douliu City (TW)

(72) Inventor: CHIN-TE SU, Douliu City (TW)

(73) Assignee: FENG TAY ENTERPRISES CO., LTD., Doullu City (TW)

(21) Appl. No.: 16/780,351

(22) Filed: Feb. 3, 2020

(30) Foreign Application Priority Data
Oct. 4, 2019 (TW) 108136089

(51) Int. Cl. B29C 64/118

(52) U.S. Cl. CPC B29C 64/118; B33Y 10/00

(57) ABSTRACT

A 3D printed thermal expansion structure includes a thermoplastic material and a thermal expansion material, wherein the thermoplastic material is in a range from 50 to 90 wt % based on a weight of the 3D printed thermal expansion structure, and the thermal expansion material is in a range from 10 to 50 wt % based on the weight of the 3D printed thermal expansion structure. The thermoplastic material and the thermal expansion material are mixed to form a mixed material, and the mixed material is utilized by a 3D printing apparatus to form a solid object, and the solid object is heated to form the 3D printed thermal expansion structure in a manufacturing method of a 3D printed thermal expansion structure provided herein.

### BACKGROUND OF THE INVENTION

### Technical Field

The present invention relates generally to a three-dimensional printed structure, and more particularly to a three-dimensional printed thermal expansion structure and a manufacturing method of the same.

### Description of Related Art

As the technology develops, a range of application of a three-dimensional printing technique (hereinafter refer as to “3D printing technique”) is wider and wider. For example, toys, daily commodities, tools, goods for car use, and even a large building could be printed by the 3D printing technique.

Although the 3D printing technique can produce a complicated structure without making molds, the 3D printing technique is restricted by a curing time, so that the production efficiency of the 3D printing technique is low and is not suitable for mass production. Therefore, when a large number of same products should be manufactured in a short period of time, according to the current technology, mass production still needs to be done by the conventional molding method of making molds. As a result, the cost of the mass-produced products couldn't be cut down effectively, and it is unable to make a product with a relatively complicated structure.

In conclusion, there is a need for the manufacturers to develop a structure applying the 3D printing technique which could achieve mass production and a manufacturing method of the same, in order to effectively promote the production efficiency of the 3D printing technique and produce products with complicated structure by utilizing the 3D printing technique.

### BRIEF SUMMARY OF THE INVENTION

In view of the above, the primary objective of the present invention is to provide a 3D printed thermal expansion structure which includes a mixed material that is a mixture of a thermoplastic material and a thermal expansion material. The mixed material of the 3D printed thermal expansion structure is made by utilizing a 3D printing apparatus and executing a heating process. In this way, the 3D printing apparatus is enabled to form a solid product with a relatively complicated structure that can then expand proportionally during the heating process to form the 3D printed thermal expansion structure. Thus, manufacturing time for making the 3D printed thermal expansion structure could be reduced.

The present invention provides a 3D printed thermal expansion structure including a thermoplastic material and a thermal expansion material, wherein the thermoplastic material is in a range from 50 to 90 wt % based on a weight of the 3D printed thermal expansion structure, and the thermal expansion material is in a range from 10 to 50 wt % based on the weight of the 3D printed thermal expansion structure. The thermoplastic material and the thermal expansion material are mixed to form a mixed, or composite, material, and the mixed material is utilized by a 3D printing apparatus to form a solid object, and the solid object is heated to expand to form the 3D printed thermal expansion structure.

In addition, the another primary objective of the present invention is to provide a manufacturing method of a 3D printed thermal expansion structure, including at least the following steps:
providing a mixed material;
utilizing a 3D printing apparatus to form the mixed material into a solid object; and
heating the solid object to make the solid object expand to form the 3D printed thermal expansion structure;
wherein, the 3D printed thermal expansion structure and the solid object have a same configuration.

The present invention further provides a 3D printed thermal expansion structure manufactured by the manufacturing method of 3D printed thermal expansion structure.

With the aforementioned design, by utilizing the 3D printing apparatus to form the mixed material, which is a mixture of the thermoplastic material and the thermal expansion material, into the solid object, and by processing the heating process then, the solid object becomes the 3D printed thermal expansion structure. As a result, the 3D printing apparatus could manufacture the product with the relatively complicated structure, and the solid object could expand proportionally during the heating process to form the 3D printed thermal expansion structure. The method provided in the present invention not only could retain the advantage of printing the product with relatively complicated structure, but also could significantly reduce the manufacturing time of manufacturing mass products via 3D printing.

### BRIEF DESCRIPTION OF THE SEVERAL VIEWS OF THE DRAWINGS

The present invention will be best understood by referring to the following detailed description of some illustrative embodiments in conjunction with the accompanying drawings, in which

FIG. 1 is a flowchart, showing the manufacturing method of the 3D printed thermal expansion structure of an embodiment according to the present invention;

FIG. 2 is a schematic diagram, showing the solid object printed by the 3D printing apparatus of the embodiment according to the present invention;

FIG. 3 is a schematic diagram, showing the solid object heated by the heating apparatus of the embodiment according to the present invention;

FIG. 4 is a schematic diagram, showing the solid object expanded to the 3D printed thermal expansion structure by using the heating apparatus of said embodiment according to the present invention;

FIG. 5 is a schematic diagram, showing a perspective view of the solid object of the embodiment according to the present invention;

FIG. 6 is a schematic diagram, showing a perspective view of the 3D printed thermal expansion structure of the embodiment according to the present invention;

FIG. 7 is a sectional view taken along the 7-7 line in FIG. 5; and

FIG. 8 is a sectional view taken along the 8-8 line in FIG. 6.

### DETAILED DESCRIPTION OF THE INVENTION

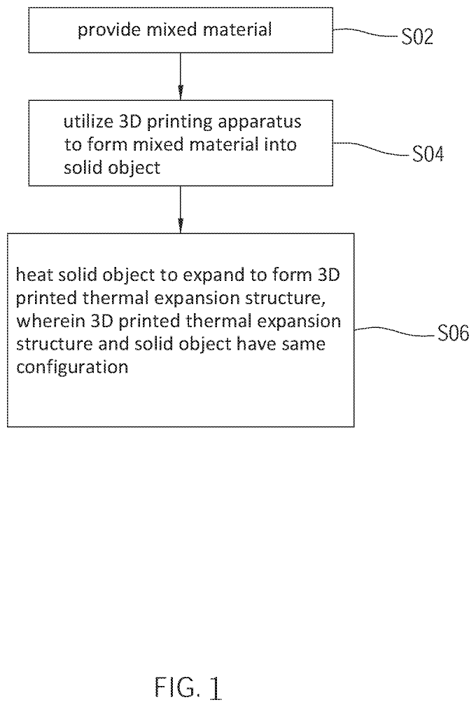

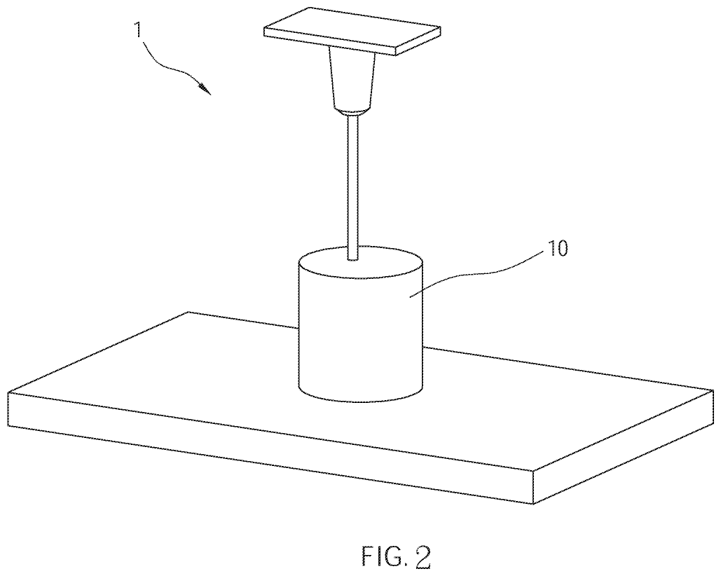

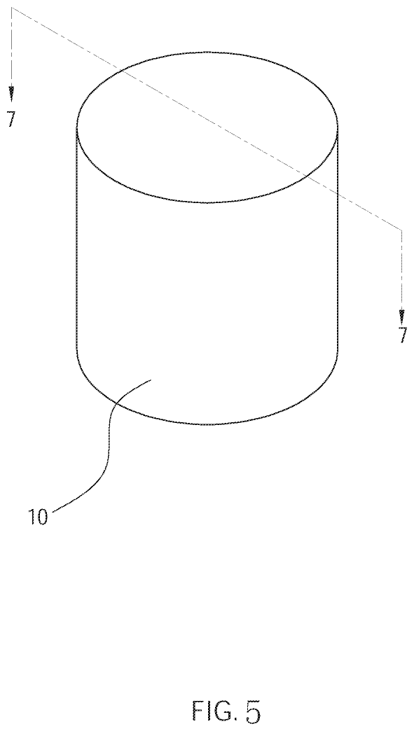

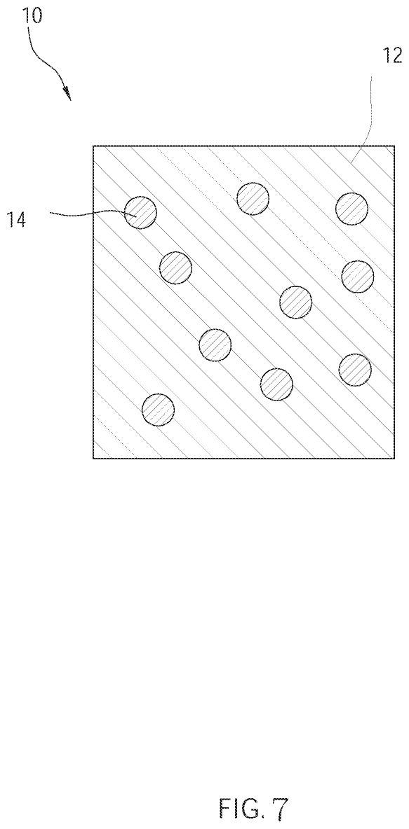

Referring to FIG. 1, FIG. 2, FIG. 5, and FIG. 7, FIG. 1 is a flowchart showing a manufacturing method of a three-dimensional printed thermal expansion structure (hereinafter refer as to “3D printed thermal expansion structure”) 20 of an embodiment according to the present invention; FIG. 2 is a schematic diagram showing a solid object 10 is printed by a 3D printing apparatus 1 of the embodiment; FIG. 5 is a schematic diagram showing a perspective view of the solid object 10 of the embodiment; and FIG. 7 is a sectional view taken along the 7-7 line in FIG. 5.

The manufacturing method of the 3D printed thermal expansion structure 20 illustrated in FIG. 1 includes at least following steps:
step S02: providing a mixed material;
step S04: utilizing the 3D printing apparatus 1 to form the mixed material into the solid object 10; and
step S06: heating the solid object 10, so that the solid object 10 expands to form the 3D printed thermal expansion structure 20, wherein the 3D printed thermal expansion structure 20 and the solid object 10 have a same configuration.

In the current embodiment, a 3D printing technique applied by the 3D printing apparatus 1 could be, but not limited to stereolithography apparatus (SLA), selective laser sintering (SLS), powder bed and inkjet head 3D printing (3DP), or fused deposition modeling (FDM).

As shown in FIG. 2, the solid object 10 includes a thermoplastic material 12 and a thermal expansion material 14, wherein the thermoplastic material 12 and the thermal expansion material 14 are mixed and formed the mixed material, and the mixed material is utilized by the 3D printing apparatus 1 to form the solid object 10. In the current embodiment, the thermoplastic material 12 accounts for 50-90 wt % of a weight of the solid object 10; the thermal expansion material 14 accounts for 10-50 wt % of the weight of the solid object 10.

In the current embodiment, the thermoplastic material 12 could be a stereolithographic material or a sinterable material, for example, but not limited to epoxy, acrylic acid, thermoplastic polyurethane (TPU), polyamide (PA), polypropylene (PP), polycarbonate (PC), or acrylonitrile butadiene styrene (ABS). In the current embodiment, the thermoplastic material 12 could be liquid or powder. If the thermoplastic material 12 is powder, the thermoplastic material 12 is pre-blended with a binder, and then is mixed with the thermal expansion material 14. In the current embodiment, if the thermoplastic material 12 and the thermal expansion material 14 are both liquid, the thermoplastic material 12 and the thermal expansion material 14 could be directly mixed; if the thermoplastic material 12 and the thermal expansion material 14 are both powder, the thermoplastic material 12 is pre-blended with the binder, and then is mixed with the thermal expansion material 14 in order to evenly mix the thermoplastic material 12 and the thermal expansion material 14. When a performance of 3D printing is not well, the thermoplastic material 12 and the thermal expansion material 14 could be kneaded in advance to obtain the mixed material, and then the mixed material is ground into a powder that is suitable for being used in the 3D printing apparatus 1. Alternatively, if the thermoplastic material 12 and the thermal expansion material 14 are liquid, the thermoplastic material 12 and the thermal expansion material 14 are sprayed in advance, and then are dried to form a powder that suitable for being used in the 3D printing apparatus 1.

In the current embodiment, the thermal expansion material 14 includes a closed-cell foam material, wherein the closed-cell foam material includes a plurality of foamable microcapsules, such as foamable microcapsules FN-78D (produced by Matsumoto Yushi-Seiyaku Co., Ltd.). In the current embodiment, a foamable raw material is pre-foamed to form the thermal expansion material 14. In the current embodiment, a volume of the thermal expansion material 14 is expanded in range of tenfold to fortyfold of a volume of the foamable raw material.

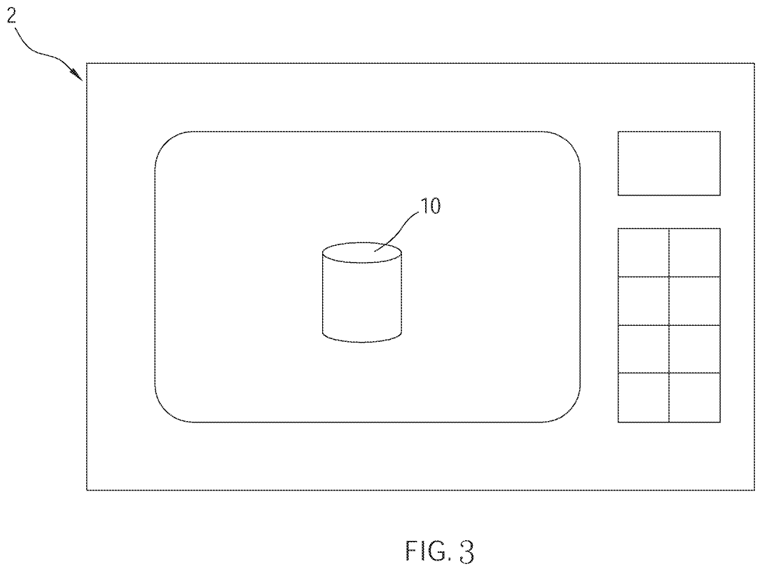

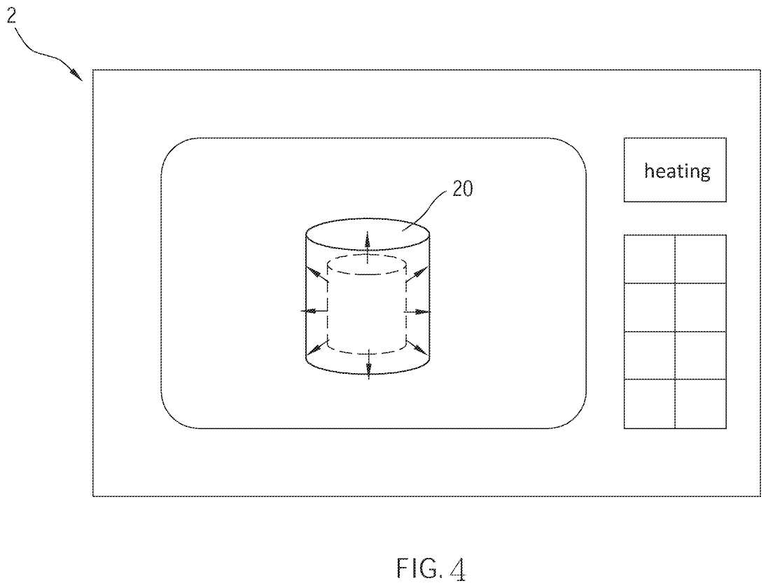

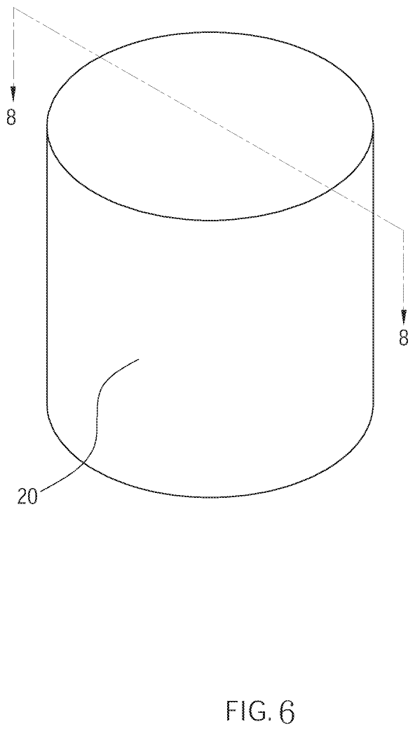

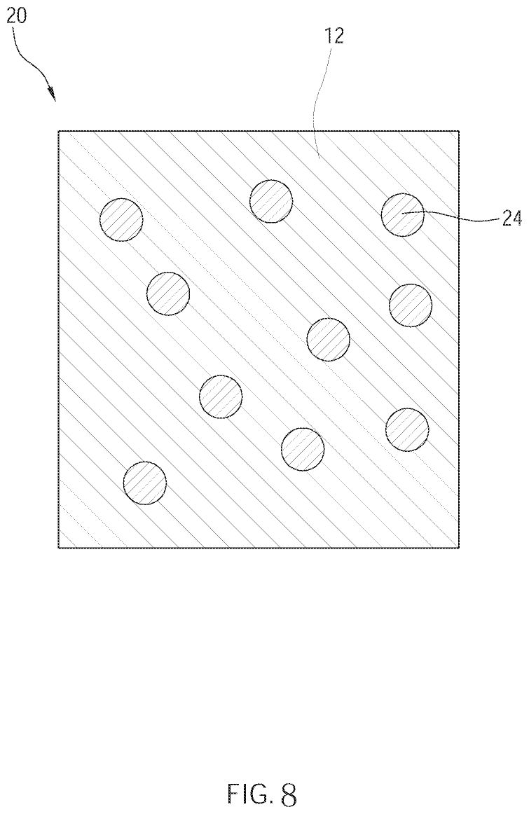

Referring to FIG. 3, FIG. 4, FIG. 6, and FIG. 8, FIG. 3 is a schematic diagram showing the solid object 10 is heated by a heating apparatus 2 of the embodiment according to present invention. FIG. 4 is a schematic diagram showing the solid object 10 is expanded to the 3D printed thermal expansion structure 20 by using the heating apparatus 2 of the said embodiment according to present invention. FIG. 6 is a schematic diagram showing a perspective view of the 3D printed thermal expansion structure 20 of the embodiment according to present invention. FIG. 8 is a sectional view taken along the 8-8 line in FIG. 6.

As shown in FIG. 3, the solid object 10 is provided into a heating apparatus 2. In the current embodiment, the heating apparatus 2 could be, but not limited to, a steamer, an oven, a microwave oven, or a laboratory oven. In other embodiments, the heating apparatus could be any apparatus which is able to heat the solid object 10. In the current embodiment, the thermal expansion material 14 in the solid object 10 is heated to expand to form a thermal expansion material 24 in the 3D printed thermal expansion structure 20. During the expansion process, a heating temperature, a power, and a heating time of the heating apparatus 2 need to be controlled, wherein the heating temperature of the heating apparatus 2 needs to be higher than an initial foaming temperature of the thermal expansion material 24 in order to foam the thermal expansion material 24 successfully. Once the heating temperature or the heating time of the heating apparatus 2 is controlled improperly, it is very possible to lead to defects that render the thermal expansion material 24 unable to foam successfully, or generates broken foam.

As shown in FIG. 4, the heating apparatus 2 heats the solid object 10, and the solid object 10 is expanded to form the 3D printed thermal expansion structure 20, wherein the 3D printed thermal expansion structure 20 and the solid object 10 have same configuration. In the current embodiment, the thermoplastic material 12 is in a range from 50 to 90 wt % based on a weight of the 3D printed thermal expansion structure 20; the thermal expansion material 14 is in range from 10 to 50 wt % based on the weight of the 3D printed thermal expansion structure 20. In the current embodiment, the solid object 10 is enlarged proportionally to form the 3D printed thermal expansion structure 20. As shown in FIG. 7 and FIG. 8, a volume of the 3D printed thermal expansion structure 20 is in a range from 1.2 to 2.5 times of a volume of the solid object 10. Once a volume change between the 3D printed thermal expansion structure 20 and the solid object 10 is less than 1.2 times, the volume change between the 3D printed thermal expansion structure 20 and the solid object 10 would be insignificant, so that a production efficiency of the 3D printed thermal expansion structure 20 would bedeficient. Once the volume change exceeds a factor of 2.5, the structure of the 3D printed thermal expansion structure 20 would become so loose that mechanical properties (physical properties) of the 3D printed thermal expansion structure 20 would not meet user's demands. In the current embodiment, a volume of the thermal expansion material 24 in the 3D printed thermal expansion structure 20 is in a range from 1.2 to 2.5 times of the volume of the thermal expansion material 14 in the solid object 10.

After the solid object 10 is heated and expanded to form the 3D printed thermal expansion structure 20, the 3D printed thermal expansion structure 20 could be processed subsequently depending on the required demand, such as grinding, cutting, cleaning, painting, coating, and other subsequent processes, and also could be engaged or bonded with other objects to meet specific requirements.

In the current embodiment, a heat deflection temperature (HDT) of the thermoplastic material 12 is lower than a heat expansion temperature of the thermal expansion material 14, 24. In the current embodiment, the HDT of the thermoplastic material 12 is listed as following table, but is not limited thereto.

| | Range of the suitable |
|---|---|
| Types of the thermoplastic material 12 | HDT (° C.) |
| Epoxy | 80-100 |
| Acrylic acid | 85-105 |
| Thermoplastic Polyurethane (TPU) | 60-100 |
| Polyamide (PA) | 160-180 |
| Polypropylene (PP) | 60-105 |
| Polycarbonate (PC) | 131-138 |
| Acrylonitrile Butadiene Styrene (ABS) | 84-95 |

With the aforementioned design, the 3D printing apparatus is used to print the solid object by the mixed material that is a mixture of the thermoplastic material and the thermal expansion material, and then through the heating process, the solid object becomes the 3D printed thermal expansion structure. As a result, the 3D printing apparatus could be utilized to produce products with relatively complicated structures, and the heating process is utilized then to proportionally expand the solid object to form the 3D printed thermal expansion structure, to thereby shorten a manufacturing time of creating the 3D printed thermal expansion structure. The method according to present invention thus not only could provides the advantage of the 3D printing technology, which is capable of producing the product with the relatively complicated structure, but also could significantly shorten the manufacturing time of mass production via the 3D printing.

It must be pointed out that the embodiment described above is only a preferred embodiment of the present invention. All equivalent methods and structures which employ the concepts disclosed in this specification and the appended claims should fall within the scope of the present invention.

What is claimed is:

1. A 3D printed thermal expansion structure, comprising:
a thermoplastic material which is in a range from 50 to 90 wt % based on a weight of the 3D printed thermal expansion structure; and
a thermal expansion material which is in a range from 10 to 50 wt % based on the weight of the 3D printed thermal expansion structure;
wherein, the thermoplastic material and the thermal expansion material are mixed to form a mixed material, and the mixed material is utilized by a 3D printing apparatus to form a solid object, and the solid object is heated to expand to form the 3D printed thermal expansion structure.

2. The 3D printed thermal expansion structure of claim 1, wherein the thermoplastic material comprises one of a stereolithographic material and a sinterable material.

3. The 3D printed thermal expansion structure of claim 1, wherein the thermoplastic material is selected from the group consisting of epoxy, acrylic acid, thermoplastic polyurethane (TPU), polyamide (PA), polypropylene (PP), polycarbonate (PC), and acrylonitrile butadiene styrene (ABS).

4. The 3D printed thermal expansion structure of claim 1, wherein the thermoplastic material is in liquid or in powder form.

5. The 3D printed thermal expansion structure of claim 4, wherein when the thermoplastic material is in powder form, the thermoplastic material is blended with a binder in advance, and then is mixed with the thermal expansion material.

6. The 3D printed thermal expansion structure of claim 1, wherein the thermal expansion material comprises a closed-cell foam material.

7. The 3D printed thermal expansion structure of claim 6, wherein the closed-cell foam material comprises a plurality of foamable microcapsules.

8. The 3D printed thermal expansion structure of claim 1, wherein the thermal expansion material is formed by pre-foaming a foamable raw material.

9. The 3D printed thermal expansion structure of claim 8, wherein a volume of the thermal expansion material is 10-40 times of a volume of the foamable raw material.

10. The 3D printed thermal expansion structure of claim 1, wherein a heat deflection temperature (HDT) of the thermoplastic material is lower than a heat expansion temperature of the thermal expansion material.

11. The 3D printed thermal expansion structure of claim 1, wherein the 3D printed thermal expansion structure and the solid object have a same configuration.

12. The 3D printed thermal expansion structure of claim 1, wherein a volume of the 3D printed thermal expansion structure is 1.2-2.5 times of a volume of the solid object.

13. A manufacturing method of a 3D printed thermal expansion structure, comprising:
providing a mixed material;
utilizing a 3D printing apparatus to form the mixed material into a solid object; and
heating the solid object to make the solid object expand to form the 3D printed thermal expansion structure;
wherein, the 3D printed thermal expansion structure and the solid object have a same configuration.

14. The manufacturing method of claim 13, wherein the mixed material comprises a thermoplastic material and a thermal expansion material; the thermoplastic material is in a range from 50 to 90 wt % based on a weight of the mixed material; the thermal expansion material is in a range from 10 to 50 wt % based on the weight of the mixed material.

15. The manufacturing method of claim 13, wherein a volume of the 3D printed thermal expansion structure is 1.2-2.5 times of a volume of the solid object.

16. The manufacturing method of claim 14, wherein the thermoplastic material is in liquid or in powder form.

17. The manufacturing method of claim 16, wherein when the thermoplastic material is in powder form, the thermoplastic material is mixed with a binder in advance, and then is mixed with the thermal expansion material.

18. The manufacturing method of claim 14, wherein the thermal expansion material is formed by pre-foaming a foamable raw material.

19. The manufacturing method of claim 18, wherein a volume of the thermal expansion material is 10-40 times of a volume of the foamable raw material.

20. The manufacturing method of claim 14, wherein a heat deflection temperature (HDT) of the thermoplastic material is lower than a heat expansion temperature of the thermal expansion material.
